(19) United States
(12) Patent Application Publication
(10) Pub. No.: US 2004/0145358 A1
(43) Pub. Date: Jul. 29, 2004

(54) Method and apparatus for minimizing power dissipation in series connected voltage regulators

(76) Inventor: Terrence Edwards Rogers, Durham, NC (US)

Correspondence Address: MYERS BIGEL SIBLEY & SAJOVEC, PO BOX 37428, RALEIGH, NC, 27627, US

(21) Appl. No.: 09/912,411

(22) Filed: Apr. 19, 2001

(51) Int. Cl. G05F 1/577

(52) U.S. Cl. 323/267

(57) ABSTRACT

Two voltage regulators are provided with the input for the second voltage regulator series connected to the output of the first voltage regulator, and the first voltage regulator powering a first circuit as well as the second voltage regulator. The second voltage regulator powers another circuit at a lower voltage than the first circuit so that when the first circuit does not require a high voltage, the output voltage of the first voltage regulator is reduced, and, therefore, the input voltage to the second voltage regulator is reduced, decreasing the voltage drop across, and the power dissipated in, the second voltage regulator.

### BACKGROUND OF THE INVENTION

1. Field of the Invention

The present invention relates to power supplies, and more particularly, to variable voltage regulated power supplies for powering electrical circuits.

2. Description of the Related Art

In the field of electronic devices, voltage regulators are known for regulating a variable power source, such as a battery pack or an AC line power supply, to provide regulated voltage to electrical circuits independent of the input voltage to the voltage regulator or the current supplied by the voltage regulator. Also known are voltage regulators electrically connected for use in series where the first voltage regulator provides a regulated voltage to the second voltage regulator and the second voltage regulator provides feedback to the first voltage regulator.

Radiotelephones and other wireless communicators are undergoing miniaturization to facilitate storage and portability. Indeed, many contemporary radiotelephones are less than 11 centimeters in length. Unfortunately, a drawback of miniaturization is that electronic components within radiotelephones may generate a substantial amount of heat during operation, which may cause them to become uncomfortably warm to a user after only a short time of operation.

Therefore, in order to facilitate miniaturization, there is increasing interest in reducing power dissipation from internal electronics so that these devices do not get uncomfortably warm to users. Moreover, there is interest in increasing battery life and in reducing manufacturing costs.

### BRIEF SUMMARY OF THE INVENTION

The present invention may be a combination of two voltage regulators connected in series where the first voltage regulator may be a switching power supply, either a buck or a boost type, and the second voltage regulator may be a series pass voltage regulator wherein the power dissipated by the series pass voltage regulator is the product of the voltage drop across it and the series pass current through it. The outputs of both regulators are used for different circuits, but the voltage output of the switching regulator is changed, also changing the input voltage to the series pass regulator, and the output of the series pass regulator remains relatively constant.

According to the present invention, two voltage regulators are connected in series such that the output voltage of the first voltage regulator is connected to the input voltage of the second voltage regulator, and the first voltage regulator output voltage is set by a controller for determining the input voltage of the second voltage regulator. The output of the first voltage regulator powers a first electrical circuit as well as providing the regulated input voltage for the second voltage regulator, and the output of the second voltage regulator powers a second electrical circuit. The first voltage regulator provides a variable regulated output voltage, as provided by the controller, in parallel to the first of the electrical circuits and to the second voltage regulator. The second voltage regulator, with a variable input voltage within a predetermined range, provides a fixed output voltage to the second electrical circuit. The first electrical circuit as well as the second voltage regulator can, therefore, be provided variable voltage for multiple modes of operation while the second voltage regulator provides a fixed regulated output voltage to the second electrical circuit, which may encompass multiple modes of operation. The output voltage of the first voltage regulator, and therefore the input voltage to the second voltage regulator, may be reduced when the first electrical circuit operates in a mode allowing a lower voltage, and therefore, the power dissipated by the second voltage regulator may be reduced due to the lower voltage drop across the second voltage regulator while it is supplying the same current level. Likewise, if the current level for the second voltage regulator is increased during this lower voltage mode, then the power savings may be even greater compared to the higher voltage mode of the second voltage regulator. In this manner, the output voltage of the first voltage regulator may be time multiplexed to provide a time varying voltage to provide the needs of the first electrical circuit and the second voltage regulator. The first voltage regulator output voltage may be decreased when the needs of the first electrical circuit allow it and increased when the needs of the first electrical circuit allow it, so that the voltage input to the second voltage regulator cycles between two voltage levels, providing a fixed regulated output voltage to the second electrical circuit but varying the voltage drop across the second voltage regulator according to the cycling of the input voltage to the second voltage regulator. The power dissipated by the second voltage regulator, is dependent on the value of power supplied to the second electrical circuit, and is defined as the product of the voltage drop across the second voltage regulator and the current the regulator supplies to the second electrical circuit. The second electrical circuit may be operated with a lower value of power to reduce the power dissipated by the second voltage regulator by coordinating modes of the second electrical circuit that draw a higher value of power to operate when the first voltage regulator output voltage is at a lower voltage level and to draw a lower value of power when the first voltage regulator output voltage is at a higher voltage level. In this way, the voltage drop across the second voltage regulator may be increased and decreased, in synchronization with the current provided to the first electrical circuit, so that power dissipation is minimized in the second voltage regulator.

According to a preferred embodiment of the present invention, two voltage regulators are connected in series, comprising: a first voltage regulator comprising an input voltage and a voltage control, the voltage control for providing a one of a plurality of output voltages; a second voltage regulator comprising an input voltage and an output voltage, wherein the first voltage regulator output voltage determines the second voltage regulator input voltage; a first electrical circuit connected to the first voltage regulator wherein the first voltage regulator output voltage is electrically connected to the first electrical circuit and the one of a plurality of output voltages is determined by the voltage control; and a second electrical circuit connected to the second voltage regulator wherein the first voltage regulator output voltage provides the input voltage to the second voltage regulator which second voltage regulator provides the output voltage to the second electrical circuit.

In another embodiment of the present invention, a wireless telecommunications device is provided, comprising: a first voltage regulator, a circuit powered by the first voltage regulator, a second voltage regulator powered by the first voltage regulator, and a circuit powered by the second voltage regulator wherein the first voltage regulator is adjusted to minimize the total power dissipation of the second voltage regulator by setting the first voltage regulator output voltage to the minimum allowed by the first electrical circuit in each of its modes of operation so that the input voltage to, and voltage drop across, the second voltage regulator is minimized.

In another embodiment of the present invention, a wireless telecommunications device is provided, comprising: a first voltage regulator, a circuit powered by the first voltage regulator, a second voltage regulator powered by the first voltage regulator, and a circuit powered by the second voltage regulator wherein there is provided a mode in which the second voltage regulator is not in regulation and the first and second electrical circuits are in a power-down mode.

### BRIEF DESCRIPTION OF THE SEVERAL VIEWS OF THE DRAWINGS

The advantages and features of the present invention will become better understood with reference to the following more detailed description and claims taken in conjunction with the accompanying drawings, in which like elements are identified with like symbols, and in which:

FIG. 1 is a block diagram showing the power supply, the voltage regulators connected in series, and the electrical circuits, according to a preferred embodiment of the present invention;

FIG. 2 shows a voltage versus time graph of the output voltage of the first voltage regulator;

FIG. 3 shows a voltage versus time graph of the output voltage of the second voltage regulator;

FIG. 4 shows a current versus time graph of the currents supplied to each of the electrical circuits;

FIG. 5 shows a voltage versus time graph of the output voltage of the first voltage regulator operating in a time-multiplexed mode;

FIG. 6 shows a voltage versus time graph of the output voltage of the second voltage regulator with the input voltage from the first voltage regulator time multiplexed as shown in FIG. 4.

### DETAILED DESCRIPTION OF THE INVENTION

1. Detailed Description of the Figures

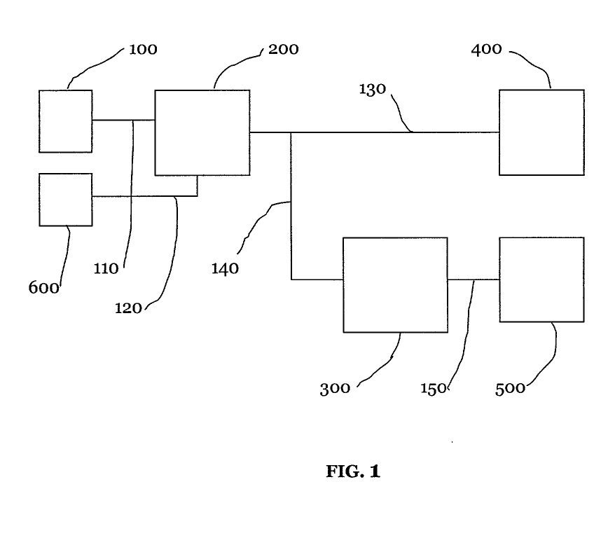

Referring now to FIG. 1, a battery, two voltage regulators connected in series, and two electrical circuits operating from the voltage regulators, are shown. A block diagram of the voltage regulator 200, the voltage regulator 300, the battery 100, the voltage control 600, the electrical circuit 400, and the electrical circuit 500 is shown in accordance with a first preferred embodiment of the present invention. The battery 100 provides connection 110 to the voltage regulator 200. The voltage control 600 provides input 120 to the voltage regulator 200 to control the common voltage outputs 130 and 140. The output voltage 130 of the voltage regulator 200 is connected to the electrical circuit 400. The output voltage 140 of the voltage regulator 200 is connected to the input voltage of the voltage regulator 300. The output voltage 150 of the voltage regulator 300 is connected to the electrical circuit 500.

Referring now to FIG. 2, and referencing FIG. 1, a voltage versus time graph is shown with three different output voltages for first voltage regulator 200, in accordance with a preferred embodiment of the present invention. In the first mode, defined as the time interval from T0 to T1, the output voltage 130 and 140 of voltage regulator 200, as controlled by the voltage control 600, is equal to V1, and may have a value, for example, of 2.75 volts. This output voltage 130 and 140 from voltage regulator 200 is supplied to electrical circuit 400 and voltage regulator 300. Likewise, in the second mode, defined as the time interval from T1 to T2, the output voltage 130 and 140 of voltage regulator 200, as controlled by the voltage control 600, is equal to V2, and may have a value, for example, of 1.75 volts. And in the third mode, defined as the time interval from T2 to T3, the output voltage 130 and 140 of voltage regulator 200, as controlled by the voltage control 600, is equal to V3, and may have a value, for example, of 1.2 volts.

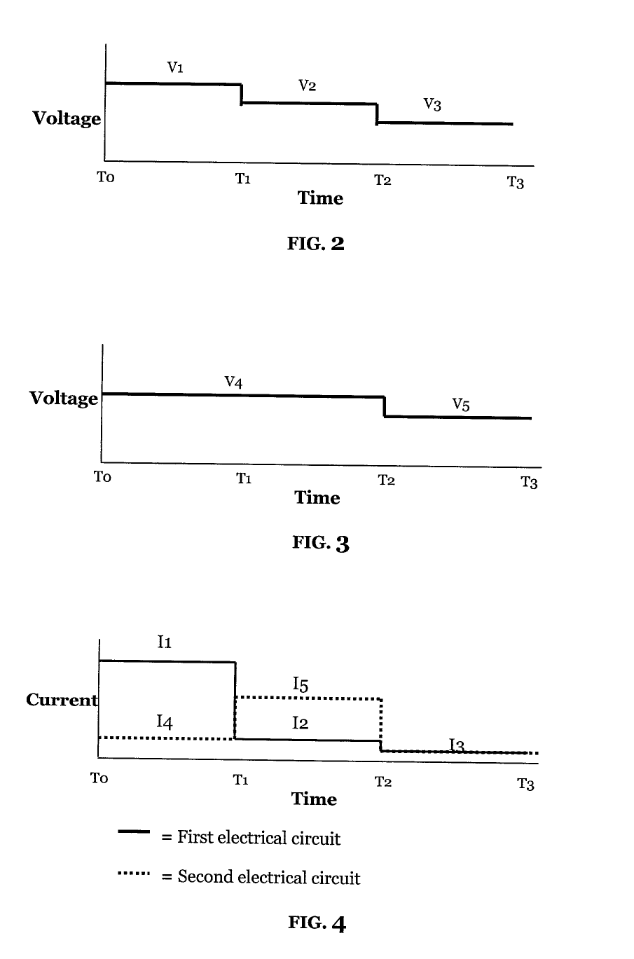

Referring now to FIG. 3, and referencing FIG. 1 and FIG. 2, a voltage versus time graph with two different output voltages for second voltage regulator 300 is shown in accordance with a preferred embodiment of the present invention. In the first mode, corresponding to the same time interval in FIG. 2 and defined as the time interval from T0 to T1, the output voltage 150 of voltage regulator 300, as controlled by voltage regulator 300, is defined as V4, and may have a value, for example, of 1.5 volts. In the second mode, corresponding to the same time interval in FIG. 2 and defined as the time interval from T1 to T2, the output voltage 150 of voltage regulator 300, as controlled by voltage regulator 300, is also defined as V4, and may have a value, for example, of 1.5 volts. In the third mode, corresponding to the same time interval in FIG. 2 and defined as the time interval from T2 to T3, the output voltage 150 of voltage regulator 300, as controlled by voltage regulator 300, is defined as V5, and may have a value, for example, of 1.1 volts.

Referring now to FIG. 4, and referencing FIG. 1, FIG. 2, and FIG. 3, a current versus time graph is shown with corresponding times for a first electrical circuit with a current of I1 for time T0 to T1, a current of I2 for time T1 to T2, and a current of I3 for time T2 to T3. For the second electrical circuit a current of I4 is shown for time T0 to T1, a current of I5 for time T1 to T2, and a current of I3 for time T2 to T3.

Taken together, FIG. 1, FIG. 2 and FIG. 3 show that in a first mode, defined as the time from T0 to T1, V1 may be the voltage for electrical circuit 400 and input voltage 140 to voltage regulator 300. V4 may be the output voltage 150 from voltage regulator 300 to electrical circuit 500. In this mode the current I1 to the electrical circuit 400 may be higher than the current I4 to electrical circuit 500. In the second mode, defined as the time from T1 to T2, V2 may be the voltage for electrical circuit 400 and input voltage 140 to voltage regulator 300. Also in the second mode, V4 may be the output voltage 150 from voltage regulator 300 to electrical circuit 500. In this mode the current I5 to the electrical circuit 500 may be higher than the current I4, and the current I2 may be lower than the current I1. In the third mode, defined as the time from T2 to T3, V3 may be the voltage for electrical circuit 400 and input voltage 140 to voltage regulator 300. V5 may be the output voltage 150 from voltage regulator 300 to electrical circuit 500. The current I3 may be lower than each of currents I1, I2, I4, and I5. The first mode may be defined as a mode in which V1 may be greater than V2 and V3, and V2 may be greater than V4. Also in the first mode I1 may be greater than I4 and I2. The second mode may be defined as one in which V2 may be less than V1 but greater than V3, V4 may be less than V2 but greater than V5, I5 may be greater than I4, and I1 may be greater than I2. In the third mode V3 may be defined as less than V4 but greater than V5, and I3 may be less than I2 and I4. As an example, voltage regulator 200 may be a buck switching regulator and voltage regulator 300 may be a fixed output series pass low dropout regulator. Electrical circuit 400 may a radio frequency transmitter and electrical circuit 500 may be a radio frequency receiver. In the first mode, voltage regulator 200 may provide the highest value of power, defined as the product of the voltage times the current, to electrical circuit 400 for active radio frequency transmission, while providing a lower value of power to electrical circuit 500 for a standby radio frequency receiver state. The radio frequency transmitter may require higher voltage operation than the receiver for the active state. The second mode may provide a lower value of power to electrical circuit 400 for a standby radio frequency transmitter state while providing a higher value of power to electrical circuit 500 for an active radio frequency receiver state. The third mode may provide the lowest value of power for both electrical circuits 400 and 500 for a power-down state. It may be seen that voltage V2 is reduced from voltage V1 when the radio frequency transmitter is in an idle state and the radio frequency receiver is in an active state. This provides for a lower voltage drop across voltage regulator 300 to minimize the power dissipation in the voltage regulator 300 when the radio frequency receiver is in an active state.

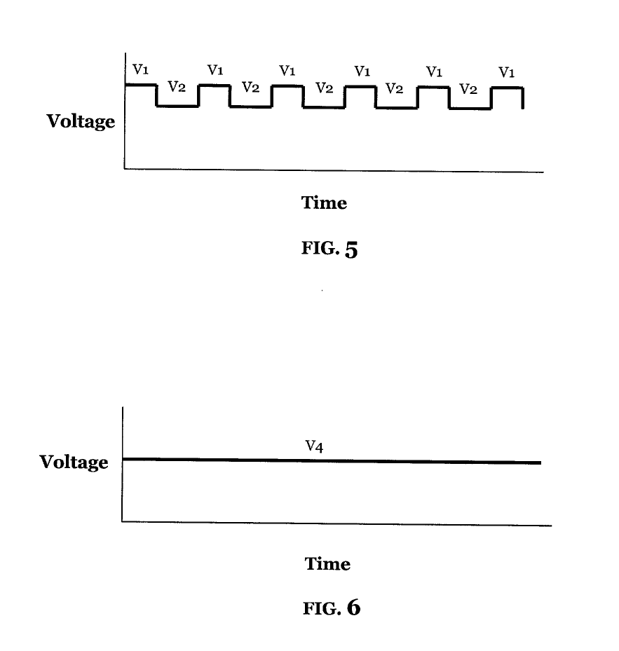

Referring now to FIG. 5, a voltage time graph with two different periodic modes, similar to the first and second modes described for FIG. 2 and FIG. 3, is shown in accordance with a preferred embodiment of the present invention. V1 and V2 correspond to V1 and V2, respectively in FIG. 2 and FIG. 3. In this manner the output voltage 130 and 140 of voltage regulator 200 is time multiplexed between V1 and V2 providing V1 when required by electrical circuit 400 and V2 otherwise. Thus the lower voltage V2 is provided to voltage regulator 300 when possible to lower the power dissipation in voltage regulator 300.

Referring now to FIG. 6, a voltage time graph with a fixed output voltage V4, corresponding to V4 in FIG. 3, for second voltage regulator 300 is shown in accordance with a preferred embodiment of the present invention. Thus even though the input voltage to voltage regulator 300 is time varying as shown in FIG. 5, the output voltage of voltage regulator 300 is V4 providing the relatively stable voltage V4 required for electrical circuit 500.

Thus, there has been shown and described an apparatus for providing an improved method for using voltage regulators connected in series to reduce power dissipation which fulfills all the objects and advantages sought therefore. Many changes, modifications, variations and other uses and applications of the subject invention will, however, become apparent to those skilled in the art after considering this specification and the accompanying drawings which disclose a preferred embodiment thereof. All such changes, modifications, variations and other uses and applications which do not depart from the spirit and scope of the invention are deemed to be covered by the invention which is limited only by the claims which follow.

What is claimed is:

1. A voltage regulation system comprising:
a first voltage regulator configured to receive an input voltage from a power source and to produce a first output voltage for a first electrical circuit;
a controller coupled to the first voltage regulator and configured to change the first output voltage to a second output voltage; and
a second voltage regulator configured to receive either of the first output voltage or the second output voltage, and to produce a third output voltage for a second electrical circuit.

2. The voltage regulation system according to claim 1, wherein the first voltage regulator comprises a buck voltage regulator.

3. The voltage regulation system according to claim 1, wherein the first voltage regulator comprises a boost voltage regulator.

4. The voltage regulation system according to claim 1, wherein the second voltage regulator comprises a series pass voltage regulator.

5. The voltage regulation system according to claim 1, wherein the first output voltage provides for a higher voltage drop across the second voltage regulator than is provided by the second output voltage.

6. The voltage regulation system according to claim 1, wherein the first voltage regulator provides for a fourth output voltage, which is less than the first and the second output voltages, and wherein the second voltage regulator provides a fifth output voltage which is less than the third output voltage.

7. The voltage regulation system according to claim 1, wherein the first electrical circuit comprises a radio frequency transmitter and the second electrical circuit comprises a radio frequency receiver.

8. The voltage regulation system according to claim 1, wherein the first output voltage provides for a first mode of operation of the first electrical circuit and the second electrical circuit, and the second output voltage provides for a second mode of operation of the first electrical circuit and the second electrical circuit.

9. The voltage regulation system according to claim 8, wherein the first mode of operation provides for radio frequency transmission for the first electrical circuit and standby for the second electrical circuit, and the second mode of operation provides for standby for the first electrical circuit and radio frequency reception for the second electrical circuit.

10. The voltage regulation system according to claim 6, wherein the fourth and the fifth output voltages provide for a third mode of operation of the first electrical circuit and the second electrical circuit.

11. The voltage regulation system according to claim 10, wherein the third mode of operation of the first electrical circuit and the second electrical circuit comprises a power down mode.

12. A method for providing multiple regulated output voltages from a power source, the method comprising:
providing an input voltage from a power source to a first voltage regulator, wherein the first voltage regulator is configured to produce a first output voltage for a first electrical circuit;
controlling the first voltage regulator to produce a second output voltage having a value less than a value of the first output voltage; and
providing either of the first output voltage or the second output voltage to a second voltage regulator, wherein the second voltage regulator is configured to receive either of the first output voltage or the second output voltage and to produce a third output voltage for a second electrical circuit.

13. The method according to claim 12, wherein controlling the first voltage regulator to produce the second output voltage is performed when the first electrical circuit operates in a mode that does not require the first output voltage.

14. The method according to claim 12, wherein the second voltage regulator provides a value of power to the second electrical circuit for the second output voltage that is greater than the value of power provided for the first output voltage.

15. The method according to claim 12, further comprising controlling the first voltage regulator to produce a fourth output voltage having a value less than a value of the second output voltage.

16. The method according to claim 15, wherein the fourth output voltage provides for a power down mode for the first and second circuits.

17. The method according to claim 12, wherein the first electrical circuit comprises a radio frequency transmitter and the second electrical circuit comprises a radio frequency receiver.

18. The method according to claim 17, wherein the first voltage output and the second voltage output are time multiplexed between a first value and a second value.

19. A radiotelephone apparatus comprising:
a power source;
a housing configured to enclose electronic components for receiving and transmitting telecommunications signals; and
a voltage regulation system disposed within the housing, comprising:
a first voltage regulator configured to receive an input voltage from the power source and to produce a first output voltage for a first electrical circuit;
a controller coupled to the first voltage regulator and configured to change the first output voltage to a second output voltage; and
a second voltage regulator configured to receive either of the first output voltage or the second output voltage, and to produce a third output voltage for a second electrical circuit.

20. The radiotelephone apparatus according to claim 19, wherein the first electrical circuit comprises a radio frequency transmitter and the second electrical circuit comprises a radio frequency receiver.
